(19) United States
(12) Patent Application Publication
(10) Pub. No.: US 2010/0005954 A1
(43) Pub. Date: Jan. 14, 2010

(54) Sound Sensing Apparatus and Musical Instrument

(76) Inventors: Yasuo Higashidate, Funabashi-shi (JP); Norikazu Kumada, Tokyo (JP); Motoaki Suzukawa, Tokyo (JP)

Correspondence Address: CARR & FERRELL LLP, 2200 GENG ROAD, PALO ALTO, CA, 94303, US

(21) Appl. No.: 12/172,261

(22) Filed: Jul. 13, 2008

(51) Int. Cl. G10H 3/14

(52) U.S. Cl. 84/725

(57) ABSTRACT

A pickup is provided in an electric guitar to detect sound generated by the electric guitar. The pickup is fitted between the housing of the body of the electric guitar and a string. The pickup includes a magnetostrictor the magnetic characteristic of which varies depending on the vibration of the string; a detector operative to detect the variation in the magnetic characteristic of the magnetostrictor as an electric signal; and a supplier operative to supply the electric signal detected by the detector to a signal processor. Certain stress is applied to the magnetostrictor by the string of the electric guitar and the housing of the body.

### BACKGROUND OF THE INVENTION

1. Field of the Invention

The present invention relates to a sound sensing apparatus for sensing sound by using a magnetostriction apparatus and a musical instrument that uses the sound sensing apparatus.

2. Description of the Related Art

Some magnetic materials undergo strain in accordance with variation in a magnetic field outside the materials. Stressing and deforming such a magnetic material changes its magnetic characteristic according to the stress. This phenomenon is called magnetostriction. Recently, materials that exhibit displacement 50-100 times greater than that of the magnetostrictors known hitherto have been discovered. Such materials are called super magnetostrictors.

By applying an alternate magnetic field to a magnetostrictor, vibration at the same frequency as that of the alternating magnetic field can be generated. It is envisaged that the phenomenon will be exploited in some way. For example, a super magnetostrictor could be applied to a bone conduction headphone or a hearing aid (see, for example, patent documents Nos. 1 and 2).
[patent document No. 1] JP 2001-258095
[patent document No. 2] JP 2004-266307

It is strongly desired that a magnetostrictor-based vibration generator provided in a headphone or a hearing aid be small and lightweight. We have proposed in patent document No. 1 mentioned above a technology for reducing the size and weight of a vibration generator by applying prestress to a super magnetostrictor so as to improve transducing efficiency, and by omitting a vibration plate so as to conduct the vibration by the super magnetostrictor directly to a target object.

We have built upon this technology and have arrived at a technology capable of achieving the small size, light weight, and high performance of a sound detector for detecting sound generated by a music instrument and converting the sound into an electric signal.

### SUMMARY OF THE INVENTION

A general purpose of the present invention is to provide a technology for achieving a small, lightweight, and high-performance sound detector.

An embodiment of the present invention relates to a sound detector. The sound detector is for detecting sound generated by a musical instrument, and comprises: a magnetostrictor the magnetic characteristic of which varies depending on the vibration of a portion of the musical instrument that generates sound; a detecting means operative to detect the variation in the magnetic characteristic of the magnetostrictor as an electric signal; and a supplying means operative to supply the electric signal detected by the detecting means to another apparatus.

The sound detector may be provided between the portion that generates sound and the housing of the musical instrument, and predetermined stress is applied to the magnetostrictor by the portion that generates sound, and the housing of the musical instrument or the housing of the sound detector. There may not be provided any components for applying the predetermined stress to the magnetostrictor. The musical instrument may be a stringed musical instrument, and the magnetostrictor may be inserted between the housing of the stringed musical instrument and a string, and certain stress may be applied to the magnetostrictor by the housing and the string. The musical instrument may be a keyboard musical instrument, and the magnetostrictor may be inserted between the housing of the keyboard musical instrument and a string hit by a keyboard, and certain stress may be applied to the magnetostrictor by the housing and the string.

Another embodiment of the present invention relates to a musical instrument. The musical instrument comprises: a sound generating means operative to generate sound when the instrument is played; and a sound detector operative to detect sound generated by the sound generating means, wherein the sound detector comprises: a magnetostrictor the magnetic characteristic of which varies depending on the vibration of the sound generating means; a detecting means operative to detect the variation in the magnetic characteristic of the magnetostrictor as an electric signal; and a supplying means operative to supply the electric signal detected by the detecting means to another apparatus.

Optional combinations of the aforementioned constituting elements, and implementations of the invention in the form of methods, apparatuses, and systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows the structure of a related-art magnetostriction apparatus;

FIG. 2 shows a table showing the characteristics of a super magnetostrictive material and a piezoelectric material;

FIGS. 3A and 3B schematically show how a magnetostrictor vibrates;

FIG. 4 shows the structure of a magnetostriction apparatus in which an improvement is made;

FIG. 5 shows the structure of a headphone as an example of an electronic appliance provided with the magnetostriction apparatus shown in FIG. 4;

FIG. 6 shows the structure of a magnetostriction apparatus according to the base technology;

FIG. 7 shows the structure of an electronic appliance according to the base technology;

FIG. 8 shows the structure of a headphone as an example of an electronic appliance provided with the magnetostriction apparatus shown in FIGS. 6 and 7;

FIG. 9 shows another structure of an electronic appliance according to a variation of the base technology;

FIG. 10 shows the appearance of an electric guitar as an example of a musical instrument according to an embodiment of the present invention;

FIG. 11 shows the appearance of a pickup according to the embodiment;

FIG. 12 shows the appearance of a pickup according to the embodiment; and

FIG. 13 shows the appearance of a piano as an example of a musical instrument according to the embodiment.

### DETAILED DESCRIPTION OF THE INVENTION

The invention will now be described by reference to the preferred embodiments. This does not intend to limit the scope of the present invention, but to exemplify the invention.

A description will first be given of a vibration generator and a vibration detector using a super magnetostrictor that embody a technology representing the base of the present invention. A description will then be given of a pickup, which is an example of a sound detector according to the present invention. In the related art, magnetic pickups and piezo pickups have been used for musical instruments. The proposed pickup according to an embodiment of the present invention uses a super magnetostrictor. Our experiments show that the pickup using a super magnetostrictor achieves a performance that far surpasses related-art magnetic pickups or piezo pickups and is capable of reproducing sound generated by a musical instrument with a high fidelity and bringing out the best of the musical instrument.

(Base Technology)

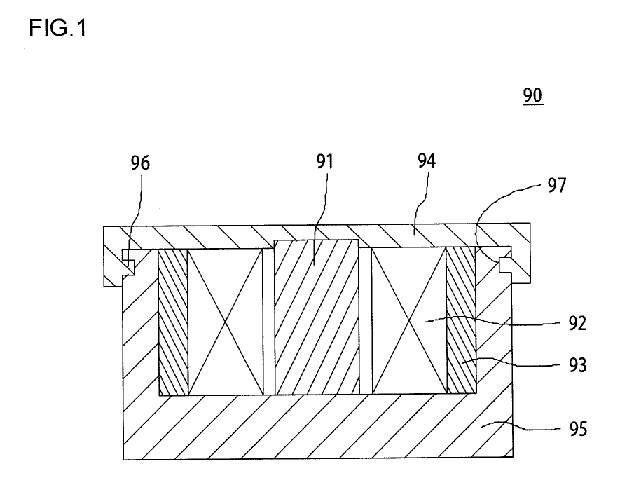

FIG. 1 shows the structure of a related-art magnetostriction apparatus. A related-art magnetostriction apparatus 90 is provided with a magnetostrictor 91, a coil 92, a bias magnet 93, a cap 94 and a case 95. The magnetostrictor 91 has a substantially cylindrical shape and is displaced such that it expands and contracts in the direction of height in accordance with a magnetic field generated by the coil 92 and the bias magnet 93. The magnetostrictor 91 is provided substantially at the center of the case 95 so that the height thereof is aligned with the depth of the substantially cylindrical case 95. The coil 92 is provided around the magnetostrictor 91. An electric current supplied from an external drive generates a magnetic field around the magnetostrictor 91. The bias magnet 93 is provided to provide a bias magnetic field of a predetermined intensity around the magnetostrictor 91 on a permanent basis. The cap 94 is substantially disk-shaped and is provided to seal the case 95 which contains the magnetostrictor 91, the coil 92 and the bias magnet 93 inside. An engagement groove 96 is formed toward the top of the side wall of the case 95. A latch part 97 of the cap 94 is latched by the engagement groove 96 so as to secure the cap 94 and the case 95 to each other. The magnetostrictor 91 is pressed from above and from below by the cap 94 and the case 95, respectively, so as to undergoes certain prestress.

As an alternating current is supplied to the coil 92, an alternating magnetic field is generated around the coil 92, causing the magnetostrictor 91 to expand and contract in the axis direction. The cap 94 vibrates as a result of the expansion and contraction of the magnetostrictor 91, and the vibration is conducted outside via the cap 94. For example, if the magnetostriction apparatus 90 shown in FIG. 1 is used in a headphone, the cap 94 is pressed against the neighborhood of the ear so as to conduct the vibration generated by the magnetostrictor 91 to the head via the cap 94. The cap 94 is formed so as to have larger elasticity than the bottom of the case 95. This prevents the vibration of the magnetostrictor 91 from being absorbed by the bottom of the case 95 and ensures that the vibration is efficiently conducted to a target object (e.g., the head of the user) via the cap 94.

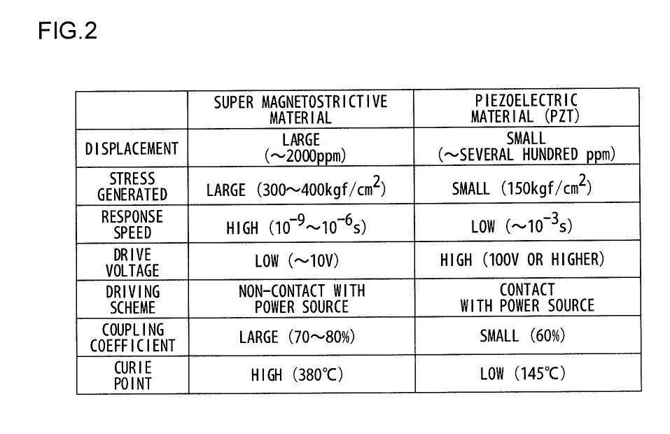

FIG. 2 shows a table showing the characteristics of a super magnetostrictive material and a piezoelectric material. A super magnetostrictive material such as terbium-dysprosium-iron (TbDyFe) has superior characteristics than a piezoelectric material such as lead zirconate titanate (PZT: PbZrO3-PbTiO3) as described below. First, a super magnetostrictive material is characterized by larger stress developed therein and relatively large displacement. Accordingly, vibration generated in a super magnetostrictor can be efficiently conducted outside. Further, since the drive voltage is lower, the power consumption is smaller. Moreover, since the Curie point is higher, it can be used in a high temperature. Since the super magnetostrictor vibrates in the presence of a magnetic field, the driven part is not in contact with a power supply. As such, the material is highly safe to use.

Moreover, a super magnetostrictive material is characterized by large stress developed therein and so can properly conduct low-frequency, high-energy vibration outside. An additional benefit of high response speed enables the material to properly follow a high-frequency input signal to generate vibration. Thus, a flat characteristic is achieved over a wide frequency range. This is particularly advantageous in a headphone or a speaker in which the material is used. A related-art headphone using a piezoelectric material can only generate sound up to about 5-20 kHz. By using a super magnetostrictive material, sound at 50 kHz or higher can be generated. It is said that humans can hear sound with a frequency of up to about 20 kHz. Some theories say that humans can hear ultrasound. Auditory perception through bone conduction has not been studied as extensively as auditory perception through an eardrum. Perception of sound in an ultrasonic range through bone conduction has yet to be explored. We envisaged to develop a headphone and a speaker using a super magnetostrictive material capable of reproducing sound in an ultrasonic range with a high fidelity, instead of using a piezoelectric material not capable of generating high-frequency sound, taking into consideration the fact that equipment has been developed recently capable of recording sound in an ultrasonic range.

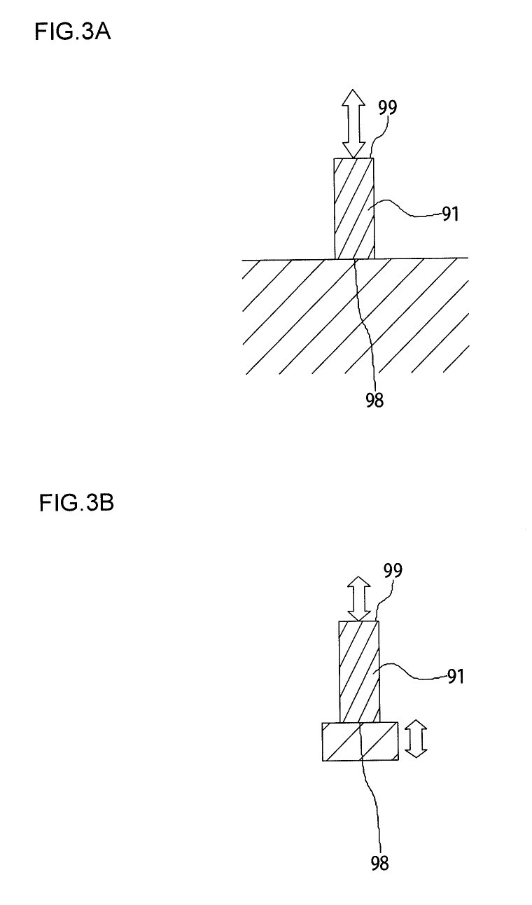

We came to be aware of challenges we face in using the excellent frequency characteristic of a super magnetostrictive material to best advantage. FIGS. 3A and 3B schematically show how a magnetostrictor vibrates. As shown in FIG. 3A, if one end (hereinafter, referred to as a “fixed end”) 98 of the magnetostrictor 91 is fixed, the magnetostrictor 91 expands and contracts only toward or away from the other end (hereinafter, referred to as an “output end”). Therefore, vibration occurring when the magnetostrictor 91 expands or contracts is efficiently conducted outside via the output end 99. If the fixed end 98 vibrates due to the fact that the member supporting the fixed end 98 of the magnetostrictor 91 is elastic or lightweight as shown in FIG. 3B, displacement of vibration or stress occurring conducted from the output end 99 outside is attenuated accordingly. As the cap 94 of the magnetostriction apparatus 90 shown in FIG. 1 is pressed against the target object to conduct the vibration of the magnetostrictor 91 to the target object, a force is generated whereby the fixed end 98 of the magnetostrictor 91 presses the bottom of the case 95 due to reaction to the force with which the cap 94 presses the target object. If the case 95 does not have enough inertial mass as shown in FIG. 3B, vibration at the output end 99 is attenuated, preventing vibration of the magnetostrictor 91 from being properly conducted to the target object. The phenomenon will be particularly noticeable in a low-frequency range characterized by high vibration energy, with the result that, for example, bass sound is difficult to hear with a headphone which uses the magnetostriction apparatus 90.

We have come to realize that the member in contact with the fixed end 98 of the magnetostrictor 91 (e.g., the case 95 of the magnetostriction apparatus 90 of FIG. 1) must have enough inertial mass and hardness in order to prohibit degradation in the frequency characteristic of the magnetostrictor 91 over a wide frequency range. It will be noted that the challenge is quite unique to a magnetostrictor, which is characterized by greater stress developed therein than in a piezoelectric device. Such a challenge has not even been aware of by developers of sound conduction apparatuses that use piezoelectric devices. It will further be noted that the challenge was identified strictly as a result of pursuing a sound conduction apparatus capable of reproducing the entirety of human audible sound with a high fidelity and persistence in covering a barely audible sound range. As described later, our experiments show that, in order to efficiently drive a super magnetostriction apparatus as a vibration generator over a wide frequency range, an inertial mass 13.8 times or larger—or, preferably, 21 times or larger, or, more preferably, 69 times or larger—than the moving mass should be provided at the fixed end 98 of the magnetostrictor 91.

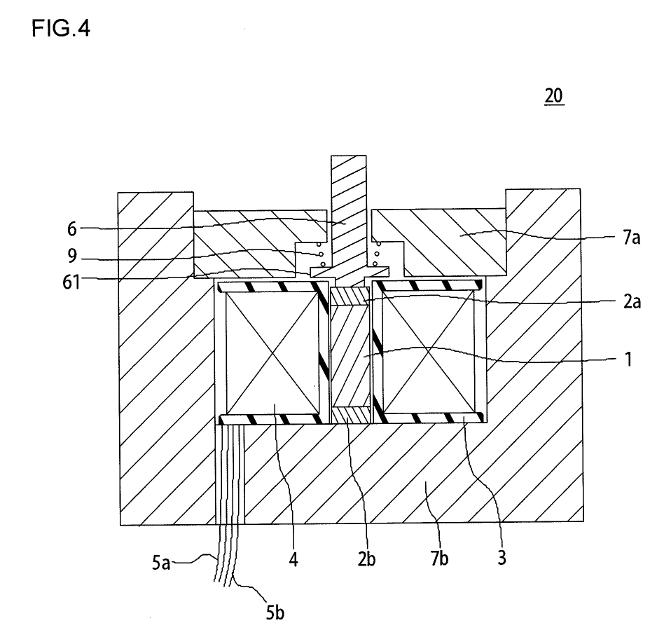

FIG. 4 shows the structure of a magnetostriction apparatus improved in view of the above-mentioned challenge. A magnetostriction apparatus 20 includes a super magnetostrictor 1, a bias magnet 2 (an upper bias magnet 2a and a lower bias magnet 2b), a bobbin 3, a coil 4, electrical leads 5a and 5b, a vibrating rod 6, a prestress cap 7a, a case 7b and an elastic member (helical spring) 9.

The super magnetostrictor 1 is used as a vibration transducer for converting a signal derived from sound into vibration. The super magnetostrictor 1 has a substantially cylindrical shape and is provided with the upper bias magnet 2a on its top and the lower bias magnet 2b on its bottom. The super magnetostrictor 1 is sandwiched between the upper bias magnet 2a and the lower bias magnet 2b and accommodated in the case 7b. The super magnetostrictor 1 is permanently exposed to a bias magnetic field generated by the upper bias magnet 2a and the lower bias magnet 2b (i.e., the bias magnetic field permanently penetrates the super magnetostrictor 1). In addition to that, it is ensured that prestress is permanently exerted on the super magnetostrictor 1 by accommodating it in the case 7b, supporting the bottom thereof by the case 7b, and pressing a vibrating rod 6 against the top thereof with the elastic force of the elastic member 9. The super magnetostrictor 1 is subjected to a variable magnetic field generated by the coil 4 disposed around the super magnetostrictor 1, while also being permanently exposed to a bias magnetic field and prestress as described above. As a result, the super magnetostrictor 1 generates vibration in response to an input electric signal.

The coil 4 is formed by wrapping a conductor line around the body of the bobbin 3 as a shaft. The bobbin 3 is made of a material such as glass substrate or polycarbonate. As an electrical signal is input to the conductor line via the electrical lead, the coil 4 generates a magnetic field 4 accordingly. By allowing the variable magnetic field generated by the coil 4 to penetrate the super magnetostrictor 1, the super magnetostrictor 1 expands or contracts in accordance with the intensity of the variable magnetic field, resulting in an output of vibration.

One end of the vibrating rod 6 is mechanically connected to the super magnetostrictor 1 via the upper bias magnet 2a so as to conduct the vibration output from the super magnetostrictor 1 outside by another end. The vibrating rod 61 is provided with a flange part 61. The flange part 61 is urged by the elastic member 9 so as to be pressed against the upper bias magnet 2a. The pressing force is applied to the super magnetostrictor 1 via the upper bias magnet 2a. The flange part 61 and the elastic member 9 prevent the entirety of the vibrating rod 6 from slipping out of the case 7b and the prestress cap 7a.

The case 7b is a container (or a body) which accommodates the super magnetostrictor 1, the upper bias magnet 2a, the lower bias magnet 2b, the bobbin 3, the coil 4, the vibrating rod 6 and the elastic member 9 assembled in a predetermined configuration. The prestress cap 7a is fixed to the case 7a by a spring mechanism, welding, caulking, resin cure or the like. In the process of fixing the prestress cap 7a to the case 7b, prestress is applied to the super magnetostrictor via the elastic member 9. By applying prestress to the super magnetostrictor 1, efficiency of transducing between an electric signal and vibration is improved. The prestress cap 7a and the case 7b are preferably formed of a magnetic material so as not to leak the internal magnetic field outside and to generate the magnetic field inside efficiently.

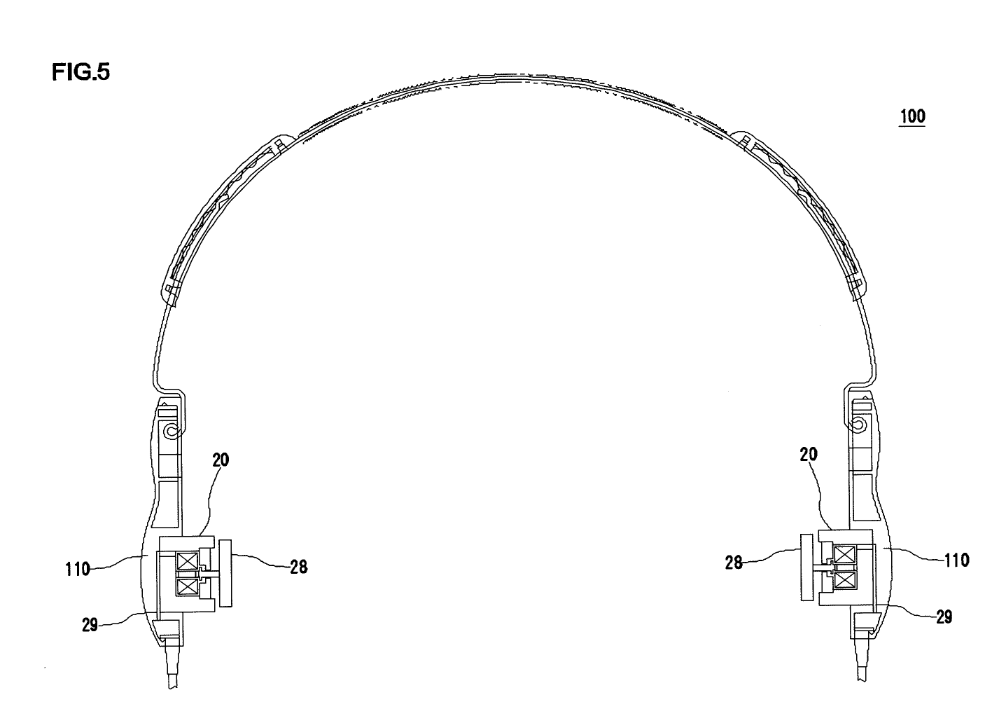

FIG. 5 shows the structure of a headphone as an example of an electronic device provided with the magnetostriction apparatus 20 as a vibration generator. A headphone 100 is provided with a main body 110, a magnetostriction apparatus 20 and a vibrating pad 28. The main body 110 includes a circuit 29 for transmitting an electric signal input from a player or the like outside the appliance to the coil of the magnetostriction apparatus 20. The vibrating pad 28 is fitted to the vibrating rod 6 of the magnetostriction apparatus 20 and conducts the vibration conducted from the vibrating rod 6 to the skull bone in the vicinity of the user's ear. The user can recognize the vibration conducted from the surface of the vibrating pad 28 as sound through bone conduction. We built a prototype of the bone-conduction headphone 100 shown in FIG. 5 and found that a wide tonal range from bass to treble is reproduced with a high fidelity, resulting in excellent acoustic property.

A magnetostriction apparatus capable of generating vibration efficiently over a wide frequency range was thus achieved. At the same time, we were also aware of the need for further reduction in size and weight of the magnetostriction apparatus as it is used in a headphone, a hearing aid, a speaker of a cell phone, etc. In the case of products such as headphones and cell phones which owe their popularity to small size and lightweight, it has been demonstrated in the market that a slight difference in size or weight affects the sales of the product severely. We are aware that, even if a product is superior to a similar, prior product in its characteristics, a slight increase in size or weight over the prior product may negatively affect consumers' desire to purchase the product. This is partly demonstrated by the fact that headphones that use piezoelectric devices are commercialized in advance of those with magnetostrictors, which is superior in performance.

Since the super magnetostrictor 1 is of a cylindrical shape and is displaced in the height direction, it is necessary to connect moving components and the height of the super magnetostrictor 1 in series. Further, in order to impart necessary vibration to a target object, the super magnetostrictor 1 should have a certain height. Therefore, a constraint is imposed in reducing its size in the height direction. Accordingly, the size and weight of the case 7b and the prestress cap 7a, which occupy a large portion of the total weight of the magnetostriction apparatus 20, need to be reduced. However, the case 7b should also have a certain inertial mass in order to maintain the low-frequency characteristic. We have arrived at a technology capable of meeting these incompatible requirements through various experiments, trials and errors.

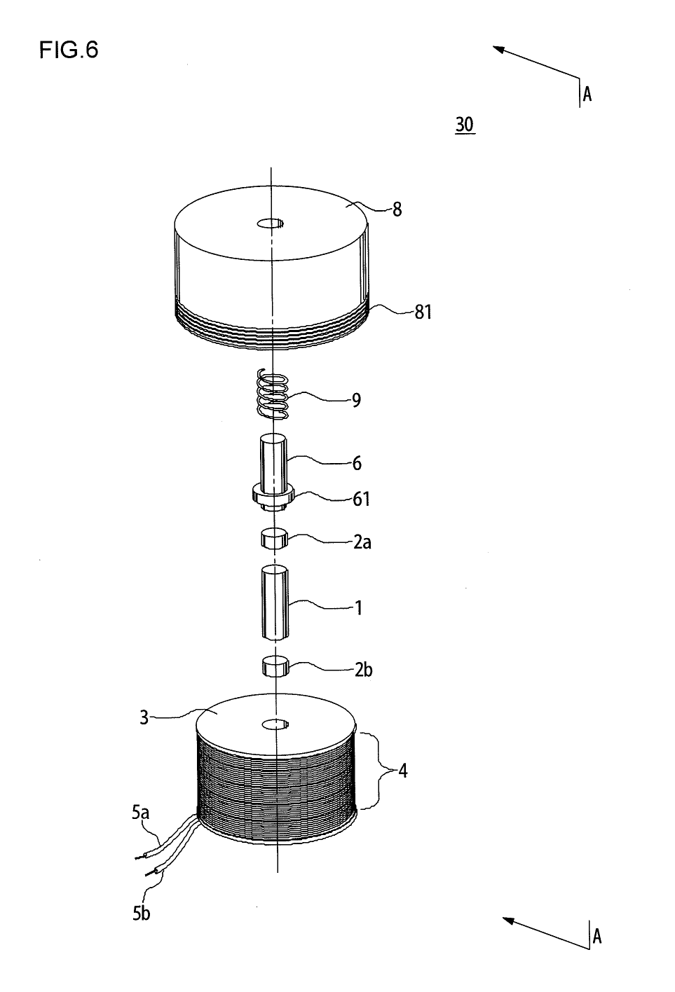

FIG. 6 shows the structure of a magnetostriction apparatus according to the base technology. Unlike the magnetostriction apparatus 20 shown in FIG. 4, a magnetostriction apparatus 30 according to the base technology is provided with a housing 8 in place of the prestress cap 7a and the case 7b. The housing 8 is provided with a screw part 81, which is an example of a connecting mechanism fitting the magnetostriction apparatus 30 to the main body of the electronic device in which the magnetostriction apparatus 30 is provided. That is, the components of the magnetostriction apparatus 30 are accommodated in the housing 8 before being fitted to the main body of the electronic device through the screw part 81. The housing 8 includes a yoke formed of, for example, a soft iron plate in order to adjust a magnetic circuit of a magnetic field generated by the bias magnet 2, the coil 4 and the electrical leads 5a and 5b and to amplify a magnetic field. The bias magnet 2, the coil 4 and the electrical leads 5a and 5b constitute a magnetic field generating means. The yoke creates a closed magnetic path within the housing 8 and prevents a magnetic field from leaking outside.

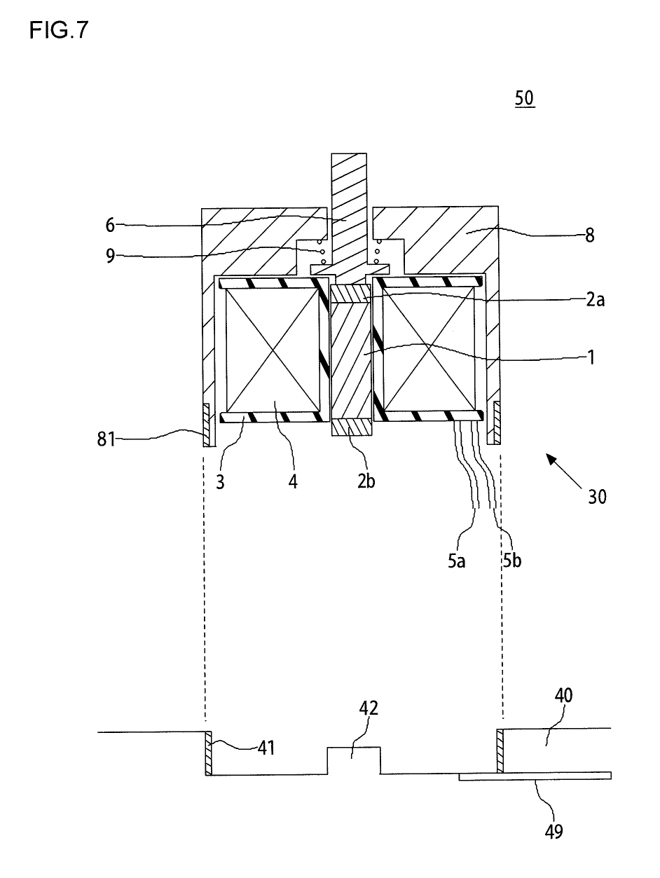

FIG. 7 schematically shows the structure of an electronic device provided with the magnetostriction apparatus 30 shown in FIG. 6. A main body 40 of the electronic device 50 is provided with a screw part 41, which is an example of a connecting mechanism for attaching the magnetostriction apparatus 30. By screwing the screw part 81 of the magnetostriction apparatus 30 and the screw part 41 of the main body 40 together, the magnetostriction apparatus 30 is fitted to the main body 40. The connecting mechanism may connect the magnetostriction apparatus 30 to the main body 40 by welding, caulking, resin cure or the like. The end of the housing 8 facing the main body 40 is open. When the magnetostriction apparatus 30 is fitted to the main body 40, the lower bias magnet 2b comes into direct contact with the main body 40. A projection 42 is provided in a position of the main body 40 which comes into contact with the lower bias magnet 2b. By tightening the screw, the super magnetostrictor 1 is pressed by the projection 42 via the lower bias magnet 2b, applying predetermined prestress to the super magnetostrictor 1. The electrical leads 5a and 5b are connected to a circuit 49 of the main body 40 so that an electrical signal supplied from the circuit 49 is transmitted to the coil 4.

In the magnetostriction apparatus 20 shown in FIG. 4, the case 7b is assigned the function of supporting the fixed end of the super magnetostrictor 1. In the magnetostriction apparatus 30 shown in FIGS. 6 and 7, the main body 40 of the electronic device 50, which includes, for example, a circuit to provide an electric signal to the magnetostriction apparatus 30, is assigned that function. That is, the housing 8 is provided to accommodate components such as the super magnetostrictor 1, the coil 4, the bias magnet 2 and the elastic member 9 and is not assigned the function of supporting the fixed end of the super magnetostrictor 1 or the function of applying prestress to the super magnetostrictor 1. By connecting the housing 8 to the main body 40, the mass of the main body 40 is made available to suppress the displacement of the fixed end of the super magnetostrictor. Accordingly, the main body 40 suppresses the displacement of the fixed end of the super magnetostrictor. Since a member external to the magnetostriction apparatus 30 is capable of suppressing the displacement of the fixed end of the super magnetostrictor, there is no need to provide a member with a large inertial mass in the magnetostriction apparatus 30. Further, the prestress cap for applying prestress to the super magnetostrictor 1 can be omitted. Consequently, this reduces the size and weight of the magnetostriction apparatus 30 and, ultimately, of the electronic device 50 as a whole.

A related-art approach requires a magnetostriction apparatus as a prerequisite, with a case and a prestress cap being built in and building the magnetostriction apparatus in, for example, an electronic device. In contrast, the magnetostriction apparatus 30 of the base technology can be fitted to any main body 40 so long as the main body 40 has sufficient mass and hardness. Accordingly, electronic devices using the magnetostriction apparatus 30 can be designed flexibly.

Insomuch as the related-art magnetostriction apparatus 90 shown in FIG. 1 requires a mechanism to apply prestress to the magnetostrictor 91, it can be said that designers have been unwittingly caught by the preconceived idea that the mechanism shall be inherently provided in the magnetostriction apparatus 90. The mechanism for supporting the fixed end of the super magnetostrictor 1 to suppress its vibration is also necessary in the magnetostriction apparatus 20 shown in FIG. 4. The mechanism is provided within the magnetostriction apparatus 20. Failure to be free from this concept has resulted in failure to reduce the size and weight of the magnetostriction apparatuses 90 and 20 and has represented a fundamental factor inhibiting wide acceptance of magnetostrictors, which far surpass piezoelectric devices in performance.

Patent document No. 2 (JP 2002-266307) discloses a technology in which a reception circuit, a battery, and a counter mass utilizing the mass of a case are provided in the housing of a speaker unit. Vibration generated as a vibrator is driven by a driving coil into expansion or contraction is efficiently transmitted to a vibrator at the other end. The technology as disclosed is no different from the related art in that a counter mass is provided in the speaker unit. It cannot be said that the weight of the speaker unit is reduced in comparison with the related art. Further, since a larger counter mass is provided at the fixed end of a magnetostrictor, the speaker unit is shaped like a stick elongated in the direction of vibration of the vibrator. It cannot be said that the size of the speaker unit is reduced in comparison with the related art.

We have changed the way of thinking toward reduction in size and weight of a magnetostrictor apparatus and, particularly, reduction in size in the direction of vibration of a vibrator, and have arrived at an idea of letting the main body 40 of the electronic device 50 to operate to apply prestress to the super magnetostrictor 1 and suppress vibration at the fixed end of the super magnetostrictor 1. This approach frees us of the preconceived idea that the magnetostriction apparatus 30 itself should have an inertial mass sufficient to suppress vibration at the fixed end of the super magnetostrictor 1 and allows us to reduce the size and weight significantly. The approach also permits omitting some of the members for sandwiching the super magnetostrictor 1 from above and below and applying prestress thereto, which successfully resulted in reduction in size of the super magnetostrictor 1 in the direction of vibration. This means that a trade-off between maintenance of frequency characteristic and reduction in size and weight is established. It will therefore be appreciated that the present invention overcomes challenges that prohibited commercial use of magnetostrictors, which are superior in characteristics, and represents a major breakthrough that facilitates wide acceptance of equipment using a magnetostrictor.

As described above, an inertial mass 13.8 times or larger than the moving weight should be provided at the fixed end in order to suppress vibration at the fixed end of the super magnetostrictor and efficiently conduct the vibration at the output end outside. For this purpose, the main body 40 should have mass approximately 13.8 times or larger—or, preferably, 21 times or larger, or, more preferably, 69 times or larger—than the total mass of the super magnetostrictor 1, the bias magnet 2, the elastic member 9 and the vibrating rod 6. If an additional part vibrated by the vibrating rod 6 (e.g., a vibrating pad for fitting the headphone close to the ear of the user) is provided, the mass of such a part shall be included in the mass of the vibrating rod 6. The mass of constituent members that can be regarded as being mechanically integral with the main body 40 may be included in the mass of the main body 40.

The member (in the example of FIG. 7, the projection 42) in the main body 40 with which the structure of the fixed end comes into contact desirably has sufficient hardness to suppress vibration at the fixed end of the super magnetostrictor 1. The housing 8 is preferably made of a magnetic material. In case the magnetostriction apparatus 30 is used in a headphone or the like, however, the housing 8 may not be formed of a magnetic material because the magnetic field generated is not so intense. In this case, the housing 8 may be formed of a light material to achieve lightweight.

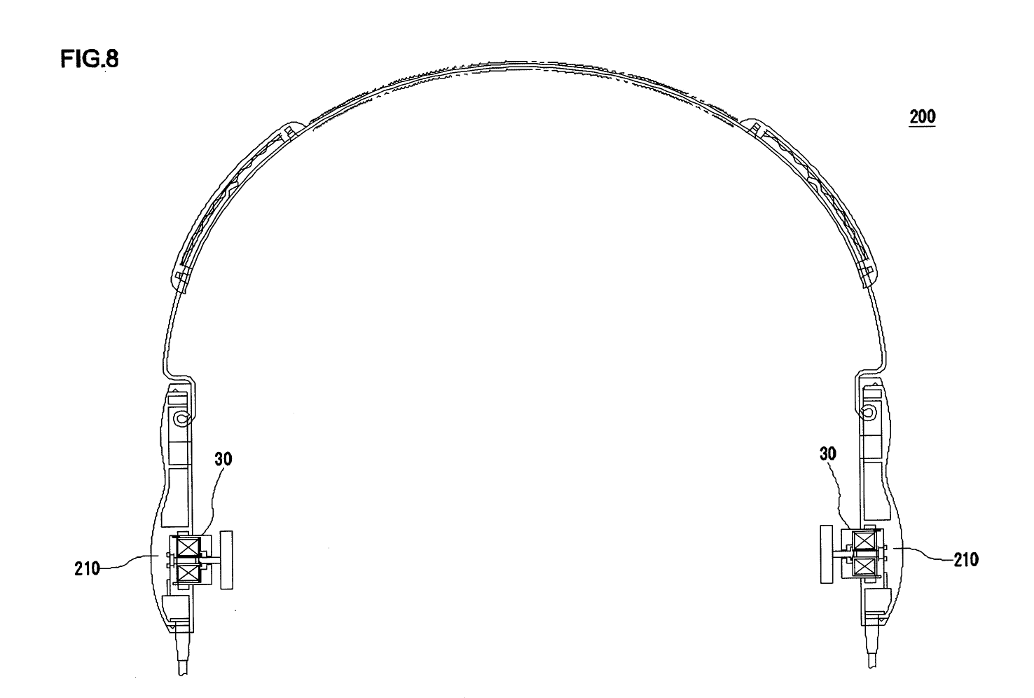

FIG. 8 shows the structure of a headphone as an example of the electronic device 50 provided with the magnetostriction apparatus 30 shown in FIG. 6. A headphone 200 is provided with the magnetostriction apparatus 30 of an open type shown in FIG. 6 instead of the magnetostriction apparatus 20 of a closed type provided in the headphone 100 shown in FIG. 5. We built a prototype of the headphone 200 shown in FIG. 8 and found that a wide tonal range, bass and treble, is reproduced with a high fidelity as in the headphone 100 shown in FIG. 5 and that excellent acoustic property is achieved.

We built prototypes of the headphone 100 of FIG. 5, which is equipped with the magnetostriction apparatus 20 of a closed cylinder type shown in FIG. 4, and of the headphone 200 of FIG. 8, which is equipped with the magnetostriction apparatus 30 of an open type shown in FIG. 6. The ratio between the moving mass and the inertial mass supporting the fixed end is examined in relation to the frequency characteristic of sound output from the headphones, by rating audio perception by the same person being tested wearing the headphones. Since it is difficult to numerically determine the frequency characteristic of sound perceived by humans through bone conduction, a difference in frequency characteristic is checked by audio perception by the person being tested.

An experiment using the magnetostriction apparatus 20 of a closed type shown in FIG. 4 demonstrated that the prototype magnetostriction apparatus 20, which has a movable part weighing 1.3 g, an inertial mass of 17.9 g supporting the fixed end and a total mass of 22.2 g, is superior to the related-art bone-conduction headphone using, for example, a piezoelectric device. That is, it was demonstrated that the inventive apparatus is capable of outputting sound of a wider frequency range. Thus, the experiment showed that the inertial mass supporting the fixed end is preferably 13.8 times or larger than the moving mass. If we include in the moving mass the mass of the vibrating pad for conducting vibration of the super magnetostrictor 1 of the magnetostriction apparatus 20 to the head of a person being tested, the inertial mass is preferably about 3.4 times or larger than the moving mass. In the prototype headphone 100 equipped with the magnetostriction apparatus 20, the inertial mass of the fixed end, including the mass of the main body, is about 90 g, which is about 69 times (9 times, if the vibrating pad is included) larger than the moving mass. This demonstrates that the headphone 100 has a characteristic superior to the bone-conduction headphone according to the related art.

Meanwhile, replacing the prestress cap 7a and the case 7b by the housing 8 resulted in the magnetostriction apparatus 30 of an open type shown in FIG. 6 weighing as little as 12.8 g. Since the mass of prototype magnetostriction apparatus 20 is 22.2 g, the mass of the magnetostriction apparatus is reduced to almost half. It is known from the experiment already mentioned that an excellent frequency characteristic is obtained by providing at the fixed end an inertial mass 13.8 times or larger—or, more preferably, 69 times or larger—than the moving mass. This shows that the main body to which the magnetostriction apparatus 30 is attached is required to have the mass. Since the moving mass of the prototype magnetostriction apparatus 30 is 1.3 g, the mass of the main body may be 17.9 g or greater. We built a prototype of the headphone 200 in which the magnetostriction apparatus 30 that weighs 12.8 g is attached to the body 40 that weighs 27 g (21 times as heavy as the moving mass) and confirmed that the headphone achieves an excellent acoustic characteristic. The headphone 200 is significantly lighter than the headphone 100, while offering excellent acoustic property as the headphone 100. The housing 8 of the prototype is formed of a metal. If the coil is contained in a yoke formed of Permalloy or the like to create a closed magnetic path, the housing 8 may be formed of a light material such as resin. This can further reduce the mass of the magnetostriction apparatus 30 and, ultimately, the mass of the apparatus like a headphone as a whole.

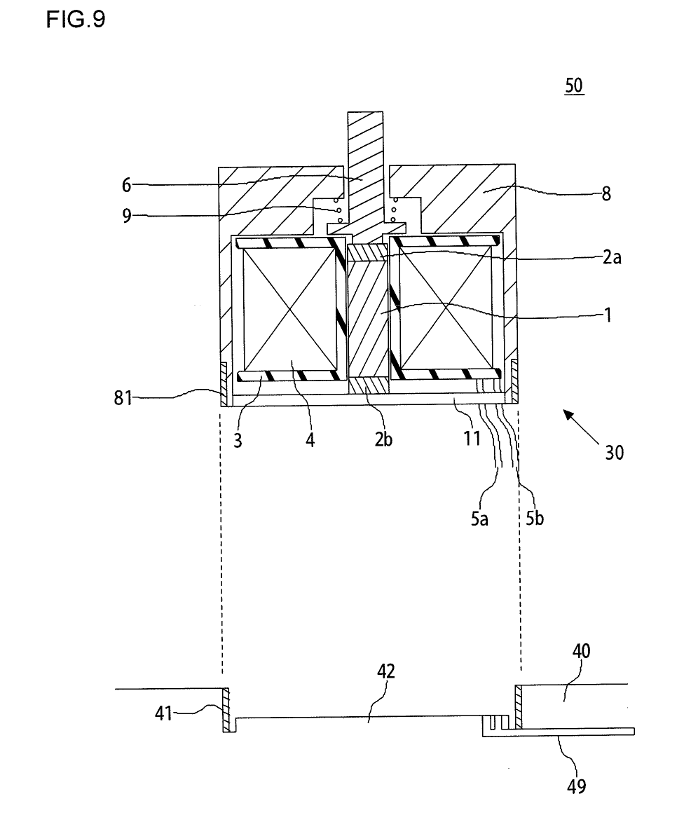

FIG. 9 shows the structure of the electronic device 50 according to a variation of the base technology. The magnetostriction apparatus 30 shown in FIG. 9 is further provided with a bottom plate 11 in addition to the components of the magnetostriction apparatus 30 shown in FIG. 7. The bottom plate 11 may be formed of a plate with waterproof finish for preventing drops of water from invading the magnetostriction apparatus 30 or the main body 40. Alternatively, the bottom plate 11 may be formed of a magnetic material to prevent leakage of magnetic field to the main body 40. Since the magnetostriction apparatus 30 of this variation is provided with the bottom plate 11 facing the main body 40, the apparatus is of a closed type instead of an open type. However, the bottom plate 11 need not have an inertial mass necessary to suppress vibration at the fixed end of the super magnetostrictor 1. The bottom plate 11 is not provided to suppress vibration at the fixed end of the super magnetostrictor 1. The inertial mass necessary to suppress vibration may be in the main body 40 of the electronic device 50.

In this case, too, the main body 40 shall have the weight 16.8 times or larger—or, preferably, 21 times or larger, or, more preferably, 69 times or larger—than the moving mass. The mass of the bottom plate 11 may be included in the mass of the main body 40. If there is some member provided between the main body 40 and the super magnetostrictor 1 in addition to the bottom plate 11, the mass of that member may be included in the mass of the main body 40. What is essential is that the fixed end of the super magnetostrictor 1 be provided with sufficient mass and hardness to suppress vibration at the fixed end. With this, vibration of the super magnetostrictor 1 is efficiently conducted outside. Also, the magnetostriction apparatus 30 is allowed to exhibit its excellent frequency characteristic in this way. A particular benefit of the magnetostriction apparatus 30 used in the headphone 200 is that sound quality is improved.

In the above description, one super magnetostrictor 1 is provided in the magnetostriction apparatus 30. Alternatively, multiple super magnetostrictors may be provided so long as the main body 40 has enough inertial mass. The size of the super magnetostrictor 1 is as desired.

An electronic device using the magnetostriction apparatus 30 as a vibration generator was described above. Alternatively, the magnetostriction apparatus 30 may be used as a vibration detector. In this case, the vibrating rod 6 has the function of conducting vibration applied from outside to the super magnetostrictor 1. The coil 4 functions as a detecting means for detecting variation in magnetic characteristic of the super magnetostrictor 1 in accordance with the vibration applied from outside, in the form of an electrical signal. In this case, too, the housing 8 is provided with a screw part 81 functioning as a connecting means for connecting the apparatus to the main body 40. The hardness and mass of main body 40 is sufficient to suppress vibration at the end of the main body 40 as the super magnetostrictor 1 is vibrated due to the vibration applied from outside. With this, vibration over a wide frequency range can be accurately detected. By eliminating the need to provide the magnetostriction apparatus 30 with a prestress cap or enough inertial mass, the size and weight of the apparatus can be reduced.

### Embodiment

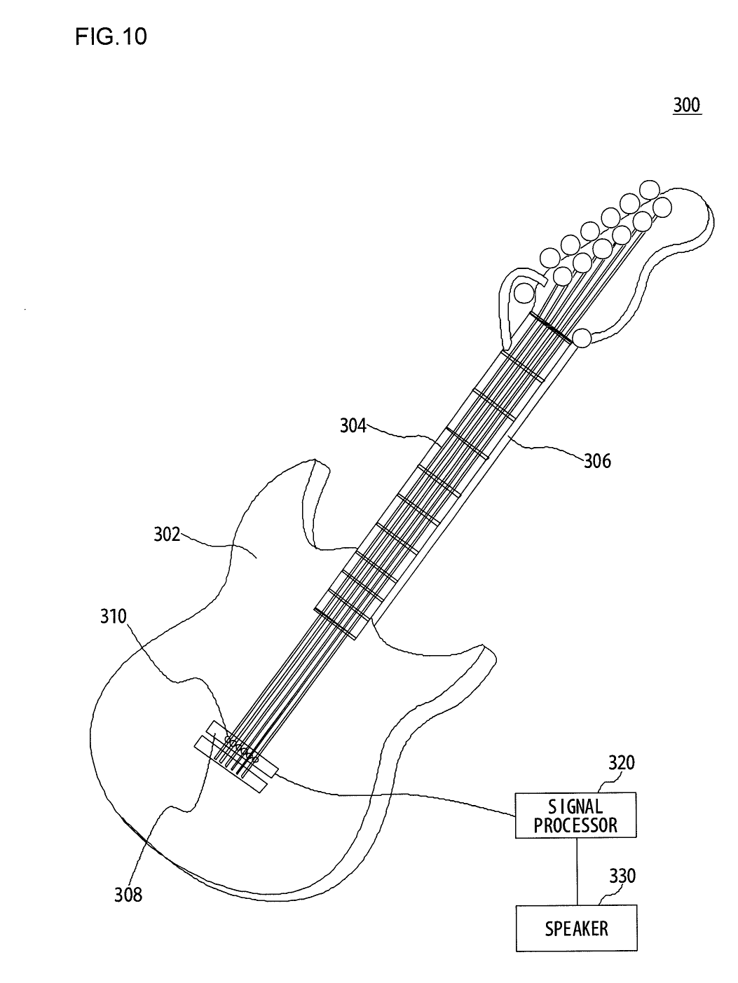

FIG. 10 shows the appearance of an electric guitar 300 as an example of a musical instrument according to the embodiment of the present invention. A pickup 310 as an example of a sound detector is provided for each of a plurality of strings 304 and is sandwiched between the housing of a body 302 of the electric guitar 300 and the string 304. The pickup 310 directly detects the vibration of the string 304, converts the vibration into an electric signal, and supplies the signal to a signal processor 320 external to the guitar. The signal processor 320 subjects the electric signal acquired from the pickup 310 to signal processing such as amplification, filtering, application of acoustic effects before supplying the signal to a speaker 330. The speaker 330 outputs the electric signal acquired from the signal processor 320 as sound. The pickup 310 may be provided in the body 302 of the electric guitar 300 or in a neck 306. In the example of FIG. 10, the pickup 310 is built in a bridge 308.

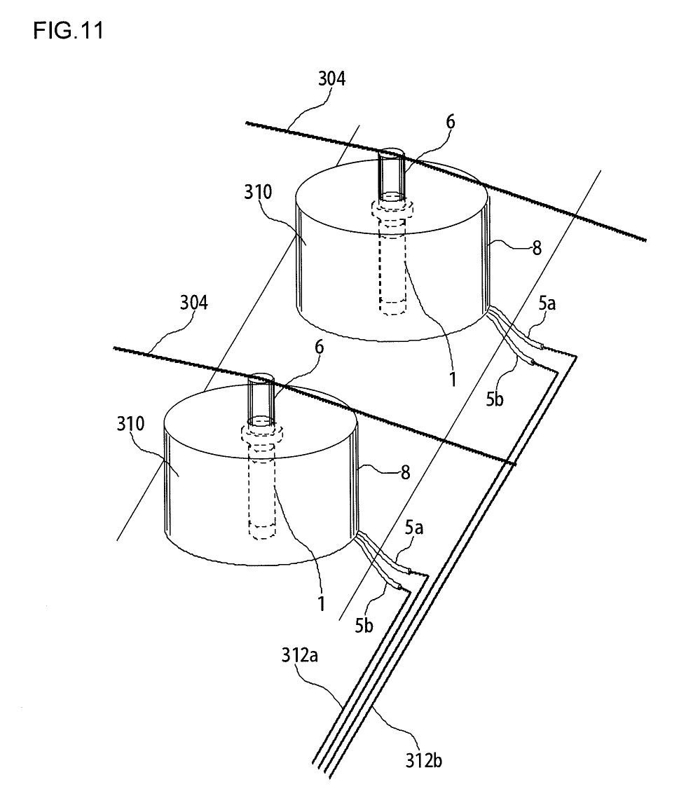

FIG. 11 shows the appearance of the pickup 310. The pickup 310 has the same structure as the magnetostriction apparatus 30 described in the base technology. The housing 8 of the pickup 310 is fitted to the body 302 of the electric guitar 300 via the bridge 308. The vibrating rod 6 of the pickup 310 is in contact with the string 304 of the electric guitar 300. The super magnetostrictor 1 of the pickup 310 is inserted between the housing of the body 302 of the electric guitar 300 and the string 304. Certain prestress is applied to the super magnetostrictor 1 by the housing of the body 302 and the string 304.

As the string 304 is vibrated by playing the guitar, the vibration of the string 304 is transmitted to the super magnetostrictor 1 via the vibrating rod 6. As the super magnetostrictor 1 is expanded or contracted due to the vibration thus transmitted, a magnetic field is created in the housing 8 and a current is induced in the coil 4. The current generated in the coil 4 is supplied to the external signal processor 320 via the electrical leads 5a and 5b. In the example shown in FIG. 11, the electrical leads 5a and 5b of the plurality of pickups 310 are connected to the signal processor 320 via mutually different leads 312a and 312b. In this way, signals from the individual pickups 310 can be acquired in isolation from each other. The signal processor 320 may extract common components from the signals acquired from the pickups 310 and isolate signals of the sound generated in the respective strings 304 by subtracting the common components from the individual signals.

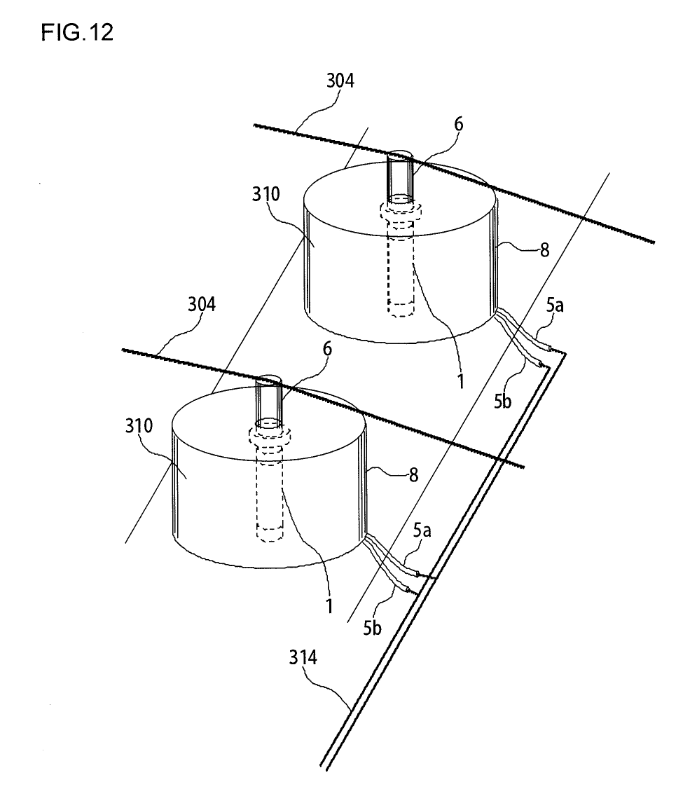

FIG. 12 shows the appearance of the pickup 310. In the example shown in FIG. 12, the electric leads 5a and 5b of the plurality of pickups 310 are connected to the signal processor 320 via a common lead 314. In this way, SN ratio is improved and noise is reduced.

As described in the base technology, the super magnetostrictor 1 far surpasses piezoelectric devices in device characteristics. Therefore, the pickup 310 according to the embodiment has much better acoustic characteristics than the related-art pickups using piezoelectric devices. For example, as shown in FIG. 2, the response speed of the super magnetostrictor 1 is 1000 times greater than that of a piezoelectric device. Accordingly, a time lag between the picking of the string 304 by a player and the output of sound from the speaker 300 is reduced. Further, since the super magnetostrictor 1 has excellent frequency characteristics, the magnetostrictor 1 can reproduce the sound generated by the string 304 with a high fidelity not only in the audible range but also in the inaudible range. Accordingly, discomfort felt by the player is minimized so that the player is allowed to be immersed in the playing. Players of classical guitars will feel less reluctant to play an electric guitar so that the use of electric guitars is promoted.

A plurality of saddles, the position or height of which is adjustable independently, may be provided in the bridge 308 for each string 304. In this case, the pickup 310 may be provided for each saddle. Adjustment of the position or height of the saddle causes the prestress applied to the super magnetostrictor 1 of the pickup 310 to vary slightly. Since the prestress to be applied to ensure an optimum magnetostriction effect of the super magnetostrictor 1 varies between 0.71-1.43 kgf/mm², the position or height of the bridge 308 and the pickup 310 may be adjusted so that the prestress applied to the super magnetostrictor 1 is located within the above range, given that the tension of the string 304 is adjusted using the saddle.

The vibrating rod 6 of the pickup 310 may be formed of the same material as the bridge 308. With this, the same sound quality as when the pickup 310 is not provided in the bridge 308 is maintained. Therefore, the true sound of the electric guitar 300 is reproduced with a high fidelity.

The pickup 310 may be provided at a plurality of different locations in the musical instrument. For example, for detection of vibration at different locations of the string 304, the pickup 310 may be provided near the bridge and near the neck. In this way, sound may be adjusted to suit the player's preference and is output accordingly.

The pickup 310 may not only be used in guitars but also in string instruments such as violin, viola, cello, contrabass, mandolin, harp, ch'in, Japanese lute, shamisen, Chinese fiddle, erh hu, matouqin, rubab, zither, and balalaika.

The pickup 310 according to the embodiment using the super magnetostrictor 1 is highly sensitive and so can detect not only the vibration of a string but also the vibration of a musical instrument itself. As such, the pickup 310 can detect resonance in a musical instrument or in a cavity provided in a musical instrument and so can fully exploit the potential of a musical instrument.

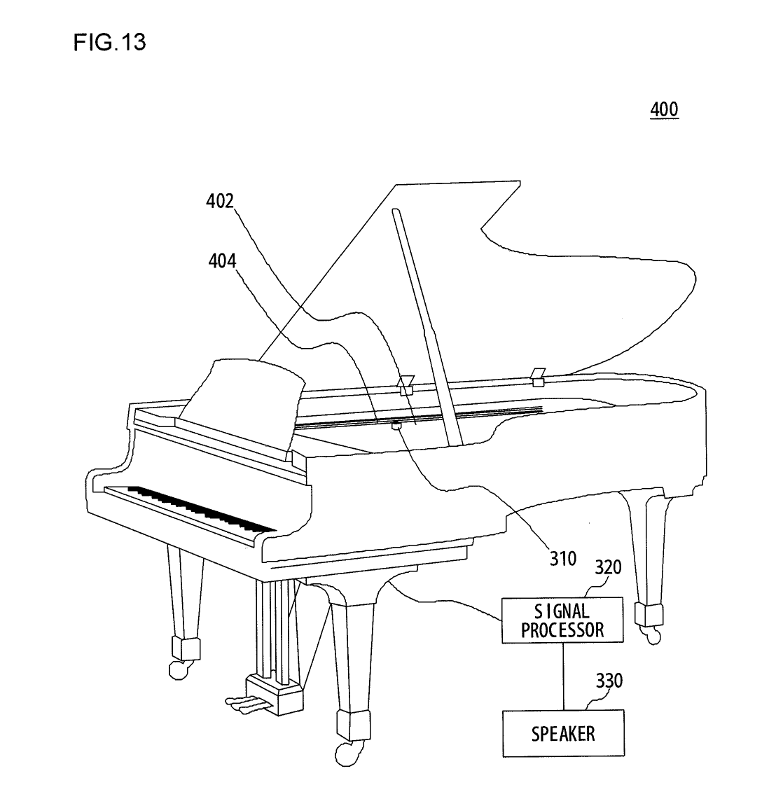

FIG. 13 shows the appearance of a piano 400 as an example of a musical instrument according to the embodiment. The above-mentioned technology may also be used in stringed keyboard instruments such as piano and cembalo. The pickup 310 is inserted between the housing of a body 402 of the piano 400 and a string 404. In this case, too, certain prestress is applied to the super magnetostrictor 1 of the pickup 310 by the housing of the body 402 of the piano 400 and the string 404. The pickup 310 detects sound generated by the string 404 as the player hits the key, converts the sound into an electrical signal, and supplies the signal to the signal processor 320. The speaker 330 converts the signal processed by the signal processor 320 into sound for output.

The magnetostriction apparatus 90 or the magnetostriction apparatus 20 described in the base technology may be used as the pickup 310 according to the embodiment. In this case, certain prestress may be applied to the super magnetostrictor 1 by the housing of the magnetostriction apparatus and by the portion of the musical instrument that originates sound (e.g., a string or a film).

For adjustment of the magnitude of the prestress applied to the super magnetostrictor 1 of the pickup 310, the position or tension of the string or the film, the size of the housing 8 of the pickup 310, the length of the vibrating rod 6, etc., may be adjusted. What is required is that an optimum prestress is applied to the super magnetostrictor 1 of the pickup 310 when the string or the film of the musical instrument is tuned to produce the true sound.

According to the technology of the embodiment, components for applying prestress that had been necessary to improve the level of saturation magnetostriction of a super magnetostrictor can be omitted from a pickup. Accordingly, the size and weight of the pickup can be reduced while maintaining the performance of the pickup. The mass of a musical instrument can be taken advantage of as a rear mass necessary to improve the performance of a super magnetostrictor. Accordingly, components for a rear mass can be eliminated from the pickup so that the size and weight of the pickup can be reduced.

Described above is an explanation of the present invention based on an embodiment. The embodiment is intended to be illustrative only and it will be obvious to those skilled in the art that various modifications to constituting elements and processes could be developed and that such modifications are also within the scope of the present invention.

What is claimed is:

1. A sound detector for detecting sound generated by a musical instrument, comprising:
a magnetostrictor the magnetic characteristic of which varies depending on the vibration of a portion of the musical instrument that generates sound;
a detecting means operative to detect the variation in the magnetic characteristic of the magnetostrictor as an electric signal; and
a supplying means operative to supply the electric signal detected by the detecting means to another apparatus.

2. The sound detector according to claim 1, wherein the sound detector is provided between the portion that generates sound and the housing of the musical instrument, and
predetermined stress is applied to the magnetostrictor by the portion that generates sound, and the housing of the musical instrument or the housing of the sound detector.

3. The sound detector according to claim 3, wherein there are not provided any components for applying the predetermined stress to the magnetostrictor.

4. The sound detector according to claim 2 or claim 3, wherein
the musical instrument is a stringed musical instrument, and
the magnetostrictor is inserted between the housing of the stringed musical instrument and a string, and certain stress is applied to the magnetostrictor by the housing and the string.

5. The sound detector according to claim 2 or claim 3, wherein
the musical instrument is a keyboard musical instrument, and
the magnetostrictor is inserted between the housing of the keyboard musical instrument and a string hit by a keyboard, and certain stress is applied to the magnetostrictor by the housing and the string.

6. A musical instrument comprising:
a sound generating means operative to generate sound when the instrument is played; and
a sound detector operative to detect sound generated by the sound generating means, wherein
the sound detector comprises:
a magnetostrictor the magnetic characteristic of which varies depending on the vibration of the sound generating means;
a detecting means operative to detect the variation in the magnetic characteristic of the magnetostrictor as an electric signal; and
a supplying means operative to supply the electric signal detected by the detecting means to another apparatus.
